(19) United States
(12) Patent Application Publication
(10) Pub. No.: US 2007/0240073 A1
(43) Pub. Date: Oct. 11, 2007

(54) Mobile communication terminal

(76) Inventors: Kevin McCarthy, Lyngby (DE); Ian Rattigan, Malmo (SE); Christian Kraft, Frederiksberg (DK); Peter Ib, Herlve (DK); Romel Amineh, Copenhagen (DK); Per Jessen, Copenhagen (DK)

Correspondence Address: PERMAN & GREEN, 425 POST ROAD, FAIRFIELD, CT, 06824, US

(21) Appl. No.: 11/400,807

(22) Filed: Apr. 7, 2006

(51) Int. Cl. G06F 9/00; G06F 3/00; G06F 17/00

(52) U.S. Cl. 715/767; 715/810; 715/864; 715/835

(57) ABSTRACT

A method for providing a user interface of a mobile communication terminal including a currently active display. The method includes displaying on the currently active display at least part of a menu, the menu having a plurality of menu items, one menu item of the plurality of menu items being in focus, conditionally shifting focus in a first direction to a menu item being located along the first direction from the menu item being in focus, the condition of shifting focus in a first direction including detecting a first input associated with the first direction, repeating at least the step of conditionally shifting focus, until a menu item being on an end of the menu has been reached, generating a user alert that an end of the menu has been reached, conditionally shifting focus to a menu item being located on an opposite end of the menu from the menu item being in focus, the condition of shifting focus to a menu item including detecting a second input, and conditionally exiting the menu, the condition of exiting including detecting a third input. A corresponding mobile communication terminal and computer program product is also presented.

### FIELD

The disclosed embodiments generally relate to mobile terminals and more particularly to user interfaces in mobile terminals.

### BACKGROUND

Mobile terminals, or mobile (cellular) telephones, for mobile telecommunications systems like GSM, UMTS, D-AMPS and CDMA2000 have been used for many years now. In the older days, mobile terminals were used almost exclusively for voice communication with other mobile terminals or stationary telephones. More recently, the use of modern terminals has been broadened to include not just voice communication, but also various other services and applications such as www/wap browsing, video telephony, electronic messaging (e.g. SMS, MMS, email, instant messaging), digital image or video recording, FM radio, music playback, electronic games, calendar/organizer/time planner, word processing, etc. To allow a user to select a desired among all the available applications, user interfaces have evolved in mobile terminals. These user interfaces often include hierarchical menus.

A problem with the modern mobile terminals is to be able to provide a simple, yet flexible, user interface, while still providing the user with suitable feedback to keep track of the current position in the menu system.

One attempt to solve this is to provide a menu system, where the user can select what action to perform in a one-dimensional, where the menu wraps around, allowing the user to for example jump from the last item in a menu to the first item in one step. However, in this wrap-around menu, it is difficult for the user to keep track of a currently highlighted menu item among all the menu items.

Consequently, there is a need to provide a simple yet flexible user interface for mobile terminals.

### SUMMARY

In view of the above, an objective of the invention is to solve or at least reduce the problems discussed above.

According to a first aspect of the invention there has been provided a method for providing a user interface of a mobile communication terminal comprising a currently active display, the method comprising the steps of: displaying on the currently active display at least part of a menu, the-menu comprising a plurality of menu items, one menu item of the plurality of menu items being in focus, conditionally shifting focus in a first direction to a menu item being located along the first direction from the menu item being in focus, the condition of shifting focus in a first direction comprising detecting a first input associated with the first direction, repeating at least the step of conditionally shifting focus, until a menu item being on an end of the menu has been reached, generating a user alert that an end of the menu has been reached, conditionally shifting focus to a menu item being located on an opposite end of the menu from the menu item being in focus, the condition of shifting focus to a menu item comprising detecting a second input, and conditionally exiting the menu, the condition of exiting comprising detecting a third input. With this method, the user is provided a way to detect that an end of the menu is reached, while still being able to wrap-around to the other end of the menu.

The step of conditionally exiting the menu may furthermore involve displaying on the currently active display a view corresponding to a view displayed on the active display prior to the at least part of a menu was displayed. In other words, the menu on the level immediately above is displayed on exit, or if such a menu does not exist, an idle screen.

The method may comprise the further step, before the step of repeating, of: conditionally shifting focus in a second direction to a menu item being located along a second direction from the menu item being in focus, the second direction being distinct from the first direction, the condition of shifting focus in a second direction comprising detecting a fourth input associated with the second direction, and the step of repeating may involve: repeating at least the step of conditionally shifting focus in a first direction and the step of conditionally shifting focus in a second direction, until a menu item being on an end of the menu has been reached. Allowing the user to navigate through the menu in two directions improves efficiency.

The user alert may be at least one alert selected from a group comprising a visual user alert, an audio user alert and a tactile user alert. This will allow the user to easily understand that an end of the menu has been reached.

The first input may be an actuation of a first key, the fourth input may be an actuation of a second key, the second input may be an actuation of a key most recently actuated during a period of time being shorter than a threshold time, and the third input may be an actuation of the key most recently actuated during a period of time being longer than a threshold time. In other words, by using either the right key or the left key, the user is able to step through the menu, wrap around to the other side and exit the menu, giving a very efficient and simple user interface.

The first input may be an actuation of a first key, the fourth input may be an actuation of a second key, the second input may be an actuation of a key most recently actuated, and the third input may be an absence of user input for a period being longer than a threshold time. Consequently, a time-out automatically exits the menu if no user action is detected, providing an automatic exit.

The first direction may be to the right and the second direction may be to the left. The first direction may be down and the second direction may be up. The described user interface is equally applicable to vertical menus, horizontal menus, or any other type of one-dimensional menus.

A second aspect of the present invention is a mobile communication terminal comprising: a display configured to be able to become active, means for displaying on the display at least part of a menu, the menu comprising a plurality of menu items, one menu item of the plurality of menu items being in focus, means for conditionally shifting focus in a first direction to a menu item being located along the first direction from the menu item being in focus, the condition of shifting focus in a first direction comprising detecting a first input associated with the first direction, means for repeating at least the step of conditionally shifting focus, until a menu item being on an end of the menu has been reached, means for generating a user alert that an end of the menu has been reached, means for conditionally shifting focus to a menu item being located on an opposite end of the menu from the menu item being in focus, the condition of shifting focus to a menu item comprising detecting a second input, and means for conditionally exiting the menu, the condition of exiting comprising detecting a third input. With this mobile communication terminal, the user is provided a way to detect that an end of the menu is reached, while still being able to wrap-around to the other end of the menu.

The mobile communication terminal may comprise a primary display and an alternative display, the display configured to be able to become active being the alternative display.

The mobile communication terminal may be of clamshell type and the alternative display may be an external display of the mobile communication terminal. This allow this simple user interface to be applied to the external display, while the main display may still be operated with a more complex user interface.

A third aspect of the present invention ia a computer program product comprising software instructions that, when executed in a mobile communication terminal, performs the method according to the first aspect.

Other objectives, features and advantages of the present invention will appear from the following detailed disclosure, as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

Embodiments of the present invention will now be described in more detail, reference being made to the enclosed drawings, in which:

FIG. 1 is a schematic illustration of a cellular telecommunication system, as an example of an environment in which the present invention may be applied.

FIGS. 2a and 2b are two schematic perspective views illustrating a mobile terminal according to an embodiment of the present invention.

FIG. 3 is a schematic block diagram representing an internal component, software and protocol structure of the mobile terminal shown in FIG. 2.

FIGS. 4a to 4e are schematic screen illustrations showing part of a user interface according to embodiments of the present invention.

### DETAILED DESCRIPTION OF THE INVENTION

Aspects of the invention now will be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout.

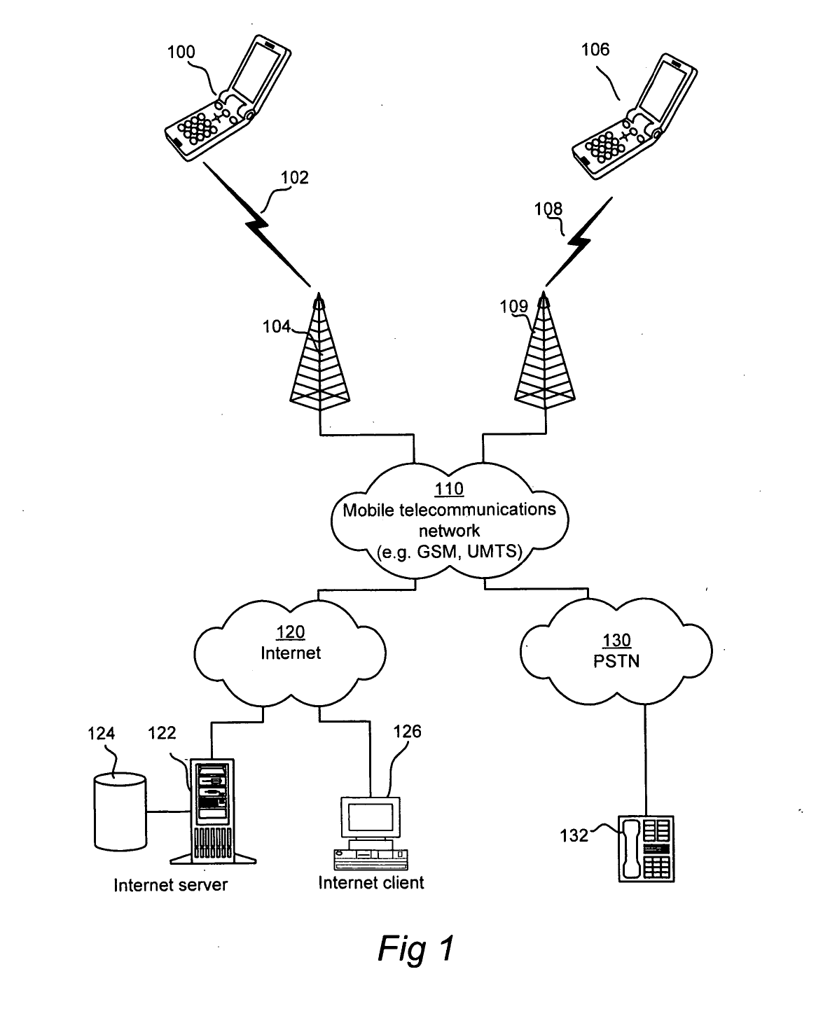

FIG. 1 illustrates an example of a cellular telecommunications system in which the invention may be applied. In the telecommunication system of FIG. 1, various telecommunications services such as cellular voice calls, www/wap browsing, cellular video calls, data calls, facsimile transmissions, music transmissions, still image transmissions, video transmissions, electronic message transmissions and electronic commerce may be performed between a mobile terminal 100 according to the present invention and other devices, such as another mobile terminal 106 or a stationary telephone 132. It is to be noted that for different embodiments of the mobile terminal 100 and in different situations, different ones of the telecommunications services referred to above may or may not be available.

The mobile terminals 100, 106 are connected to a mobile telecommunications network 110. through RF links 102, 108 via base stations 104, 109. The mobile telecommunications network 110 may be in compliance with any commercially available mobile telecommunications standard and/or protocol suite, such as GSM, UMTS, D-AMPS, CDMA2000, FOMA and TD-SCDMA.

The mobile telecommunications network 110 is operatively connected to a wide area network 120, which may be Internet or a part thereof. An Internet server 122 has a data storage 124 and is connected to the wide area network 120, as is an Internet client computer 126. The server 122 may host a www/wap server capable of serving www/wap content to the mobile terminal 100.

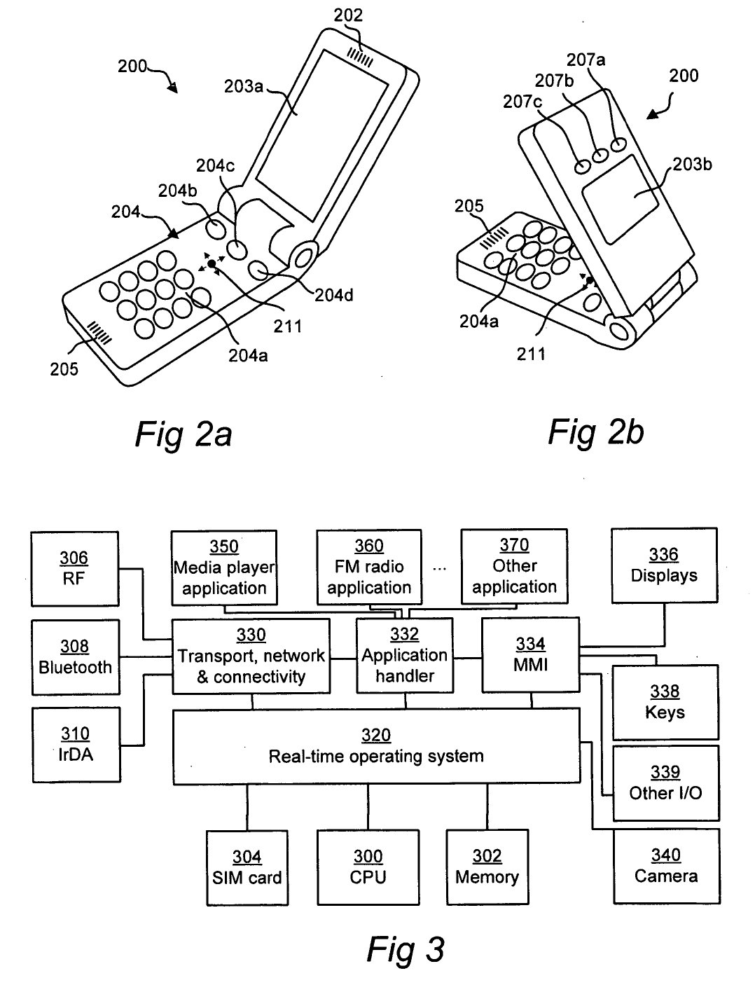

An embodiment 200 of the mobile terminal 100 is illustrated in more detail in FIGS. 2a and 2b. In this embodiment, the mobile terminal is of a type known in the industry as a clam-shell mobile terminal. This type of mobile terminal is foldable and comprises two displays: one main internal display 203a and one alternative external display 203b. The mobile terminal 200 further comprises a speaker or earphone 202, a microphone 205 and a set of internal keys 204 which may include a keypad 204a of common ITU-T type (alpha-numerical keypad representing characters “0”-“9”, “*” and “#”) and certain other keys such as soft keys 204b, 204c, 204d and a joystick 211 or other type of navigational input device. Moreover, there is provided an external set of keys 207, in this embodiment comprising three keys 207a, 207b and 207c, externally on the mobile terminal.

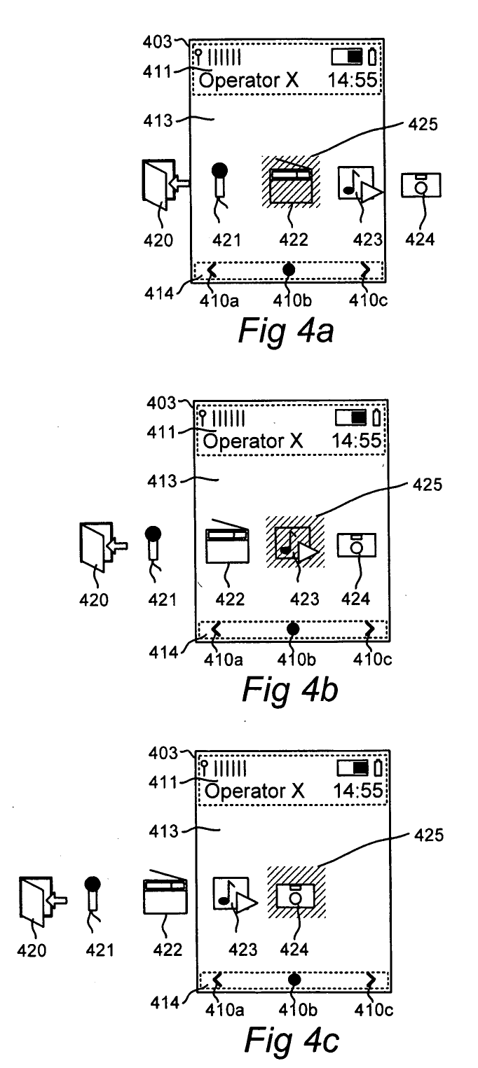

The internal component, software and protocol structure of the mobile terminal 200 will now be described with reference to FIG. 3. The mobile terminal has a controller 300 which is responsible for the overall operation of the mobile terminal and may be implemented by any commercially available CPU (“Central Processing Unit”), DSP (“Digital Signal Processor”) or any other electronic programmable logic device. The controller 300 has associated electronic memory 302 such as RAM memory, ROM memory, EEPROM memory, flash memory, or any combination thereof. The memory 302 is used for various purposes by the controller 300, one of them being for storing data and program instructions for various software in the mobile terminal. The software includes a real-time operating system 320, drivers for a man-machine interface (MMI) 334, an application handler 332 as well as various applications. The applications include a media player application 350, an FM radio application 360, as well as various other applications 370, such as applications for voice calling, video calling, sending and receiving SMS, MMS or email, an instant messaging application, a phone book application, a calendar application, a word processing application, a presentation application, a spreadsheet application, a control panel application, a camera application, one or more video games, etc.

The MMI 334 also includes one or more hardware controllers, which together with the MMI drivers cooperate with the displays 336 (internal and external where applicable), keys 338 (internal and external where applicable) as well as various other I/O devices 339 such as microphone, speaker, vibrator, ringtone generator, LED indicator, etc. As is commonly known, the user may operate the mobile terminal through the man-machine interface thus formed.

The software also includes various modules, protocol stacks, drivers, etc., which are commonly designated as 330 and which provide communication services (such as transport, network and connectivity) for an RF interface 306, and optionally a Bluetooth interface 308 and/or an IrDA interface 310. The RF interface 306 comprises an internal or external antenna as well as appropriate radio circuitry for establishing and maintaining a wireless link to a base station (e.g. the link 102 and base station 104 in FIG. 1). As is well known to a person skilled in the art, the radio circuitry comprises a series of analogue and digital electronic components, together forming a radio receiver and transmitter. These components include, i.a., band pass filters, amplifiers, mixers, local oscillators, low pass filters, AD/DA converters, etc.

The mobile terminal also has a SIM card 304 and an associated reader. As is commonly known, the SIM card 304 comprises a processor as well as local work and data memory.

Hereinbelow follows a description of a few user interface scenarios according to embodiments of the present invention.

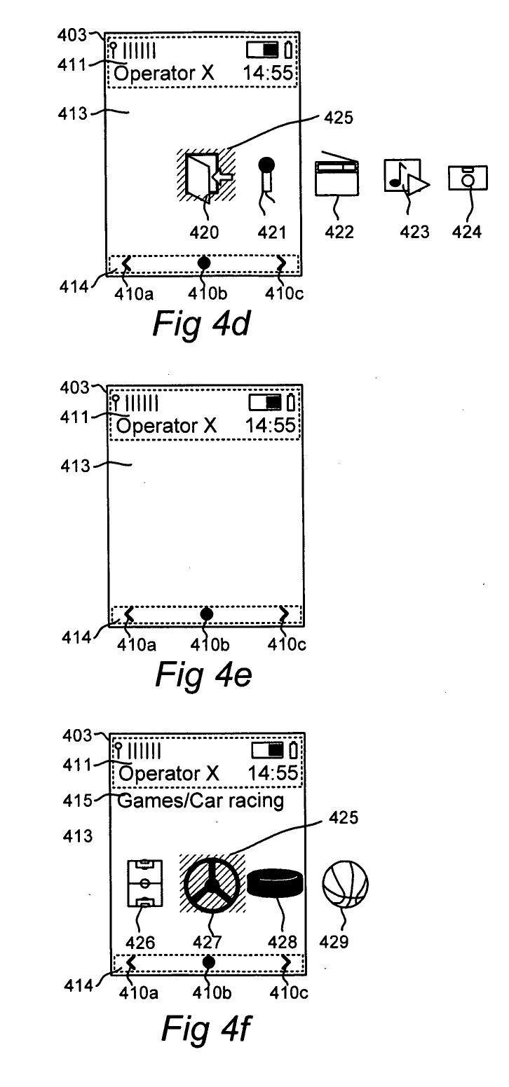

FIGS. 4a to 4e are schematic screen illustrations showing part of a user interface according to embodiments of the present invention. A screen 403, such as the external display 203b of FIG. 2b, is used to render output of a user interface of an embodiment of the present invention. The display is divided into three zones, a status zone 411, a menu zone 413 and a key label zone 414. The status zone 411 contains operational information of the mobile terminal, such as current signal strength, battery level, operator, current time, etc.

The key label zone 414 comprises three labels, a left indicator 410a, an activate indicator 410b and a right indicator 410c. The three labels 410a-c are respectively associated with three keys, such as keys 207a-c of FIG. 2b.

The menu zone 413 comprises a number of menu items, or icons, allowing the user to choose an action to be performed by the mobile terminal. In FIG. 4a, there are five menu items: a exit icon 420, a sound recorder icon 421, an FM radio icon 422, a media player icon 423 and a camera icon 424. As the display 403 only can fit three icons, only the sound recorder icon 421, the FM radio icon 422 and the media player icon 423 are visible to the user. The exit icon 420 is logically located to the left of the sound recorder icon 421, which is illustrated by the exit icon 420 being located to the left of the display 403. Consequently, the exit icon 420 is not actually visible on the display 403 in FIG. 4a. Correspondingly, the camera icon 424 is logically to the right of the media player icon 423 and is not displayed on the display 403 in FIG. 4a. One icon, in the case of FIG. 4a the FM radio icon 422, is highlighted. In this example, the highlighting is performed with shading 425 of the background for the focused icon, but any other suitable method of highlighting can be used, such as inverting, a relative increase in size, enhancing contrast, color enhancement, etc.

If the user presses the key associated with the right indicator 410c, the icons 420-424 are shifted one step to the left and the displays shows a view seen in FIG. 4b. Now the exit icon 420 and the sound recorder icon 421 are invisible and the FM radio icon 422, the media player icon 423 and the camera icon 424 are visible. Now the media player icon 423 is in focus.

If the user once more presses the key associated with the right indicator 410c, the icons 420-424 are shifted one more step to the left and the displays shows a view seen in FIG. 4c. Now the exit icon 420, the sound recorder icon 421 and the FM radio icon 422 are invisible and the media player icon 423 and the camera icon 424 are visible. Now the media camera icon 423 is in focus.

Now that an end of the menu has been reached (the camera icon 423 which is in focus does not have any more icons to the right), in one embodiment, this is indicated to the user with a user alert. The user alert can be a visual indication, an audio indication, a tactile indication or a combination of any of these. The tactile indication may for example be a vibration, or if a jog dial is used, an temporarily increased resistance of that jog dial. In this way, the user is clearly notified that the end of the menu is reached and that there are no more alternatives in the direction the user has been navigating through the menu.

The user may then choose to shift focus to a menu item on the other end of the menu. This may for example be effected by the user once again pressing the key associated with the right indicator 410c for a period of time shorter than a threshold time (also known as a short press), providing the user with an enhanced menu wrap around feature. The display then shows a view as the view in FIG. 4d. Here the exit icon 420 and the sound recorder icon 421 are displayed on the display 403 while the FM radio icon 422, the media player icon 423 and the camera icon 424 are invisible. The exit icon 420, which is the icon located on the opposite end from the camera icon 424 which was previously in focus, is now in focus.

On the other hand, from the situation in FIG. 4c, the user may decide that none of the icons in the menu are desirable to be actuated by the user presently and may wish to exit the menu. In the embodiment shown, the user can exit by activating the exit icon 420. In another embodiment, this can for example be effected by the user holding the key associated with the right indicator 410c down for a time longer than a threshold time (also known as a long press). The menu is then exited and the display shows a view as the view shown in FIG. 4e.

While it is here described a short press to wrap around the menu and a long press to exit the menu, any two distinguishable user inputs may be used. For example, a timeout, when no user input has been detected during a predetermined time, can trigger the menu to be exited.

The menu works in a corresponding way if the user navigates to the left using a key associated with the left indicator 410a. For example, in the situation shown in FIG. 4d, if the user long-presses the key associated with the left indicator 410a, the menu is exited, while if the user short presses the key associated with the left indicator 410a, the menu wraps around and the user is shown a view as the view shown in FIG. 4c.

A user interface is thus formed where the user can navigate through a list of potential choices using the keys associated with the left indicator 410a and the right indicator 410c, while receiving clear feedback where the ends of the menu are and still having the possibility of wrapping around the menu. Once the user has placed an icon corresponding to a desired action in the highlighted area 424, the action is simply activated by pressing the key associated with the activate indicator 410b. This user interface is simple, yet flexible enough to allow an arbitrary number of actions.

FIG. 4f shows an example where the described user interface has been used to navigate through a menu hierarchy. An icon shown in the menu zone 413 may either be an intermediate node with additional items below it, or a leaf with an action associated with it. For example, a menu may have a top level consisting of items such as media applications, games, phone settings, phone directory, etc. Of these, media applications and games are intermediate nodes, while phone settings and phone directory are leafs, where applications are started immediately upon activation. If the user for example navigates to games, there are a number of sub-items shown in the menu zone 413, such as a soccer game 426, a car racing game 427, a hockey game 428, a basketball game 429, etc. The user may then focus the car racing game 427, resulting in a view such as the view shown in FIG. 4e. The hierarchy above and including the current node is shown in the menu zone 413 as a hierarchy representation 415. The hierarchy representation 415 here is shown as text information, but a graphical representation of the hierarchy is equally possible.

The invention has mainly been described above with reference to a few embodiments. However, as is readily appreciated by a person skilled in the art, other embodiments than those disclosed above are equally possible within the scope of the invention, as defined by the appended patent claims.

What is claimed is:

1. A method for providing a user interface of a mobile communication terminal comprising a currently active display, said method comprising:
displaying on said currently active display at least part of a menu, said menu comprising a plurality of menu items, one menu item of said plurality of menu items being in focus,
conditionally shifting focus in a first direction to a menu item being located along said first direction from said menu item being in focus, said condition of shifting focus in a first direction comprising detecting a first input associated with said first direction,
repeating at least the conditionally shifting focus, until a menu item being on an end of said menu has been reached,
generating a user alert that an end of the menu has been reached,
conditionally shifting focus to a menu item being located on an opposite end of said menu from said menu item being in focus, said condition of shifting focus to a menu item comprising detecting a second input, and
conditionally exiting said menu, said condition of exiting comprising detecting a third input.

2. The method for providing a user interface according to claim 1, wherein conditionally exiting said menu furthermore involves displaying on said currently active display a view corresponding to a view displayed on said active display prior to said at least part of a menu was displayed.

3. The method for providing a user interface according to claim 1, further comprising, before repeating at least the conditionally shifting focus, until a menu item being on an end of said menu has been reached,
conditionally shifting focus in a second direction to a menu item being located along a second direction from said menu item being in focus, said second direction being distinct from said first direction, said condition of shifting focus in a second direction comprising detecting a fourth input associated with said second direction,
and wherein said repeating involves:
repeating at least conditionally shifting focus in a first direction and said step of conditionally shifting focus in a second direction, until a menu item being on an end of said menu has been reached.

4. The method for providing a user interface according to claim 1, wherein in giving a user alert that an end of the menu has been reached, said user alert is at least one alert selected from a group comprising a visual user alert, an audio user alert and a tactile user alert.

5. The method for providing a user interface according to claim 3, wherein:
said first input is an actuation of a first key,
said fourth input is an actuation of a second key,
said second input is an actuation of a key most recently actuated during a period of time being shorter than a threshold time, and
said third input is an actuation of said key most recently actuated during a period of time being longer than a threshold time.

6. The method for providing a user interface according to claim 3, wherein:
said first input is an actuation of a first key,
said fourth input is an actuation of a second key,
said second input is an actuation of a key most recently actuated, and
said third input is an absence of user input for a period being longer than a threshold time.

7. The method for providing a user interface according to claim 3, wherein said first direction is to the right and said second direction is to the left.

8. The method for providing a user interface according to claim 3, wherein said first direction is down and said second direction is up.

9. A mobile communication terminal comprising:
a display configured to be able to become active,
means for displaying on said display at least part of a menu, said menu comprising a plurality of menu items, one menu item of said plurality of menu items being in focus,
means for conditionally shifting focus in a first direction to a menu item being located along said first direction from said menu item being in focus, said condition of shifting focus in a first direction comprising detecting a first input associated with said first direction,
means for repeating at least said step of conditionally shifting focus, until a menu item being on an end of said menu has been reached,
means for generating a user alert that an end of the menu has been reached,
means for conditionally shifting focus to a menu item being located on an opposite end of said menu from said menu item being in focus, said condition of shifting focus to a menu item comprising detecting a second input, and
means for conditionally exiting said menu, said condition of exiting comprising detecting a third input.

10. The mobile communication terminal according to claim 9, wherein said mobile communication terminal comprises a primary display and an alternative display, said display configured to be able to become active being said alternative display.

11. The mobile communication terminal according to claim 10, wherein said mobile communication terminal is of clamshell type and said alternative display is an external display of said mobile communication terminal.

12. A computer program product comprising software instructions that, when executed in a mobile communication terminal, performs the method according to claim 1.
